(19) United States
(12) Patent Application Publication
(10) Pub. No.: US 2025/0104467 A1
(43) Pub. Date: Mar. 27, 2025

(54) SYSTEM FOR IDENTIFYING A SUBJECT

(71) Applicant: TRINAMIX GMBH, Ludwigshafen (DE)

(72) Inventors: Patrick SCHINDLER, Ludwigshafen (DE); Peter SCHILLEN, Ludwigshafen (DE); Christian LENNARTZ, Ludwigshafen (DE); Nicolas WIPFLER, Ludwigshafen (DE); Muhammad Muneeb HASSAN, Ludwighshafen (DE)

(21) Appl. No.: 18/729,578

(22) PCT Filed: Feb. 15, 2023
(86) PCT No.: PCT/EP23/53751

§ 371 Date: Jul. 17, 2024

(30) Foreign Application Priority Data
Feb. 15, 2022 (EP) 22156840.5

(51) Int. Cl. G06V 40/12; G06V 10/145; G06V 10/74; G06V 40/13; G06V 40/14; G06V 40/16; G06V 40/70

(52) U.S. Cl. CPC G06V 40/1365; G06V 10/145; G06V 10/761; G06V 40/1318; G06V 40/1341; G06V 40/14; G06V 40/172; G06V 40/70

(57) ABSTRACT

Disclosed herein is a system for identifying a subject interacting with a display device, where the system includes i) an image providing unit for providing a first image showing a first body part of the subject and a second image showing a second body part of the subject, where the first and the second image have been acquired by imaging the first and second body part, respectively, through a display of the display device, ii) a combined similarity determining unit for determining a combined degree of similarity of a) the first and the second image to b) a first and a second reference image corresponding to a reference subject identity, and iii) a subject identity determining unit for determining whether an identity of the subject corresponds to the reference subject identity based on the combined degree of similarity.

### FIELD OF THE INVENTION

The invention relates to a system, a method and a computer program for identifying a subject interacting with a display device, and to a display device.

### BACKGROUND OF THE INVENTION

Identifying a user of a display device, such as a smartphone, may be necessary, for instance, for assessing whether the user is permitted to use the display device. Due to the convenience for the user associated with them and their relatively high reliability, face detection algorithms carried out on an image acquired by a front camera of the display device are often a preferred way for identifying the user. However, when the front camera is covered by the display, which can be preferred for other reasons, images acquired by the front camera may be disturbed, which can render face detection algorithms carried out on front camera images less reliable. Whether a user is permitted to use the display device may then no longer be reliably assessed. There is therefore a need for improved means for identifying a subject interacting with a display device.

US 2019/0310724 A1 relates to an electronic device including a display defining an active display area comprising a first pixel region and a second pixel region, an opaque backing below the display defining an aperture below the second pixel region, and an optical imaging array positioned below the aperture configured to receive light reflected from a touch input provided above the second pixel region and through the display between two or more pixels of the second pixel region. The touch input can correspond to a user's finger touching the display, wherein, for imaging the user's finger, the display may illuminate the finger, such as by illuminating a region of the display below the finger. US 2017/0041314 A1 refers to a biometric information management method based on a first comparison of first biometric input information with registered first biometric authentication information and a second comparison of second biometric input information with registered second biometric authentication information. US 2020/0285722 A1 relates to palmprint sensing for access to an electronic system.

### SUMMARY OF THE INVENTION

It is an object of the invention to provide improved means for identifying a subject interacting with a display device.

In a first aspect, a system for identifying a subject interacting with a display device is provided, the system comprising a) an image providing unit for providing a first image showing a first body part of the subject and a second image showing a second body part of the subject, wherein the first image has been acquired by imaging the first body part through a display of the display device and the second image has been acquired by imaging the second body part through the display, b) a combined similarity determining unit for determining a combined degree of similarity of the first image and the second image to a first reference image and a second reference image, wherein the first reference image and the second reference image correspond to a reference subject identity, and c) a subject identity determining unit for determining whether an identity of the subject corresponds to the reference subject identity based on the combined degree of similarity.

Using images of a body part of a subject for identifying the subject allows for identifying the subject in terms of biometrical information. This can generally make the identification process relatively reliable while not causing any inconvenience for the subject which might be caused when relying on the subject's knowledge or possessions for identification. Since a first image showing a first body part of the subject and a second image showing a second body part of the subject are provided, wherein the first image has been acquired by imaging the first body part through the display and the second image has been acquired by imaging the second body part through the display, the amount of biometrical information accessible for identification can be increased even in case of a subject interacting with a display device having a display-covered camera, thereby allowing for an increased reliability of the identification without any substantial increase in inconvenience caused for the subject. Since, moreover, it is determined whether an identity of the subject corresponds to the reference subject identity based on the combined degree of similarity of a) the first image and the second image to b) a first reference image and a second reference image, wherein the first reference image and the second reference image correspond to a reference subject identity, any biometrical information from the first image and the second image can be synergistically combined in their use for the identification process. For instance, the biometrical information from the first image and the second image can complement each other and/or be partially redundant, thereby rendering the identification process more reliable and/or allowing for a focus on the particularly reliable parts of the biometrical information encoded in each of the images, thereby allowing for a decreased need for computational resources. The increased reliability of the identification process may also express itself in terms of an increased flexibility and/or robustness. For instance, under exceptional circumstances, such as in particular weather conditions or when following strict hygienic measures, subjects may be forced to wear pieces of clothing or accessories occluding critical body parts like their eyes, other parts of their face or their hands, wherein the remaining body parts may be less suitable for identification purposes. Hence, generally improved means for identifying a subject interacting with a display device are provided.

A subject interacting with a display device preferably refers to a user using the device, but could also mean, for instance, that the subject is only looking at the display of the device or is trying to gain access to or be granted access by the device.

The image providing unit is configured to provide the first image, the second image and possibly further images of the same or further body parts of the subject. It is understood that the acquisition of the first image and the second image may differ from each other. The image providing unit may also be configured to provide more than two images, wherein then all of the provided images may show a respective body part of the subject, and wherein the images may be acquired by imaging the respective body part through the display. The image providing unit may receive the one or more images from an image sensor, such as of a front camera of a smartphone, for instance, and then provide the one or more images for further processing.

The combined similarity determining unit is configured to determine the combined degree of similarity, which is a degree of similarity between a) the pair of images consisting of the first image and the second image and b) the pair of images consisting of the first reference image and the second reference image. The first and the second reference image, which correspond to a reference subject identity, are particularly indicative of the reference subject identity. The first reference image is an image showing a first body part of the reference subject having the reference subject identity, and the second reference image is an image showing a second body part of the reference subject having the reference subject identity.

The combined degree of similarity can refer, for instance, to a combination of a first degree of similarity and a second degree of similarity, wherein the first degree of similarity refers to a degree of similarity between the first image and the first reference image, and the second degree of similarity refers to a degree of similarity between the second image and the second reference image. A degree of similarity could also be referred to as a match value or score.

It may be preferred that, for determining whether an identity of the subject corresponds to the reference subject identity in a given instance of interaction between the subject and the display device, a combined degree of similarity is used as a basis that has been determined using a first image and a second image that have been acquired in the given instance of interaction, i.e. using images showing respective body parts actually being in the vicinity of, particularly in front of, the display device in the given instance of interaction.

It is understood that the first body part and the second body part of the reference subject shown in the first and the second reference image, respectively, preferably correspond to the first body part and the second body part of the subject to be identified shown in the first image and the second image, respectively. The first body part and the second body part are preferably characteristic of subjects to be identified, i.e., suitable for distinguishing a given subject from other subjects. The first body part and the second body part are preferably different from each other. If the subject to be identified is a human, they may, for instance, be chosen from the following body parts: a face, a part of a face, a finger, a part of a finger such as particularly a fingertip, a hand, a part of a hand such as particularly a palm or a back of a hand. It may be preferred that the first and/or the second body part are imaged in a state where they have a non-zero distance to the display of the display device, i.e. where they are not in contact with the display. This allows for acquiring first and second images including features based on which subjects can be identified more reliably, particularly acquiring images corresponding to a field of view sufficient to show two body parts at the same time. For instance, it may be preferred that the first and/or the second body part are imaged in a state where they have a distance higher than 2 cm, more preferably higher than 5 cm, yet more preferably higher than 10 cm, to the display of the display device.

The subject identity determining unit is configured to determine whether the identity of the subject corresponds to the reference subject identity based on the combined degree of similarity. For instance, it may be assumed that the identity corresponds to the reference subject identity if the combined degree of similarity is above a predefined threshold.

The identity of the reference subject, i.e. the reference subject identity, preferably defines a possible identity of the subject to be identified. The identity of a subject may therefore be defined in terms of biometrical characteristics, particularly characteristics of its first and second body part. Often, these characteristics may suffice to uniquely identify a subject.

However, it is also possible that different subjects are assumed to share a same identity, namely if they have sufficiently similar body parts. The risk of confusion of different subjects, i.e. of associating different subjects with a same identity, may generally decrease with an increasing number of reference subject identities, particularly if the reference subject identities are appropriately distributed in terms of the associated characteristics of the respective body parts. Identifying a subject may also be referred to as authenticating the subject.

In some embodiments, the combined similarity determining unit is configured to determine a respective combined degree of similarity of a) the first image and the second image to b) a plurality of first reference images and a plurality of second reference images, wherein each, i.e. each pair, of the plurality of first and second reference images corresponds to a respective, particularly different, reference subject identity, wherein the subject identity determining unit may be configured to determine the identity of the subject based on the respective, i.e. the plurality of, combined degrees of similarity. For instance, the identity of the subject may be assumed to correspond to the reference subject identity for which the highest combined degree of similarity has been determined.

In some embodiments, the first image has been acquired by projecting a first illumination pattern through the display onto the first body part and imaging the illuminated first body part through the display. As already indicated above, the acquisition of the first image and the second image may differ from each other. Hence, in particular, the second image may be acquired without projecting any illumination pattern through the display onto the second body part. For instance, the second image may be acquired passively, i.e. by not illuminating the second body part at all, or by illuminating the second part such that no particular illumination pattern is generated, such as by uniformly illuminating it and/or illuminating it with floodlight, particularly through the display. In some embodiments, however, the second image has been acquired by projecting a second illumination pattern through the display onto the second body part and imaging the illuminated second body part through the display. If the image providing unit is configured to provide more than two images, wherein each of the provided images shows a respective body part of the subject, some of the images may have been acquired by projecting an illumination pattern through the display of the display device onto a respective body part and imaging the respective illuminated body part through the display, and others of the images may have been acquired by imaging another or the same respective body part through the display, particularly without projecting an illumination pattern on the other or the same respective body part.

An illumination pattern may be projected simultaneously to generating uniform illumination and/or floodlight generation, such as by using two separate illumination sources. Hence, the second image can be acquired by projecting a second illumination pattern through the display onto the second body part and/or illuminating the second body part uniformly through the display, and by imaging the illuminated second body part through the display. For instance, a patterned illumination source may be used for projecting the illumination pattern through the display onto the second body part, wherein simultaneously a further illumination source, which could be referred to as uniform illumination source and/or a floodlight generator, may be used for illuminating the second body part uniformly through the display. The patterned illumination source may, for example, correspond to a laser in combination with a diffractive optical element (DOE), or to a VCSEL array, and the further illumination source, i.e. the uniform illumination source and/or floodlight generator, could correspond to a light emitting diode (LED).

Instead of projecting the illumination pattern simultaneously to generating the uniform illumination and/or floodlight, the illumination pattern may also be generated before and/or after generating the uniform illumination and/or floodlight, wherein both may be repeated one or more times. Also in this case two illumination sources, i.e. a patterned illumination source and a uniform illumination source and/or floodlight generator as indicated above, can be used.

In some embodiments, the image providing unit is configured to provide the first image and the second image based on a common image of the subject, wherein the first image corresponds to a first patch of the common image and the second image corresponds to a second patch of the common image. The common image can have been acquired by projecting a common illumination pattern through the display of the display device onto the first body part, and possibly also the second body part, and imaging the illuminated first body part and the second body part, which may be illuminated as well, through the display. The common image can also have been acquired by any of the following: a) projecting a first illumination pattern through the display onto the first body part and illuminating the second body part uniformly and/or with floodlight through the display, b) projecting a first illumination pattern through the display onto the first body part and a second illumination pattern through the display onto the second body part, c) projecting a first illumination pattern through the display onto the first body part and a second illumination pattern through the display onto the second body part, and illuminating the second body part additionally uniformly and/or with floodlight through the display, wherein in all of the cases a) to c), the first body part and the second body part, which in each case are illuminated, are imaged through the display, thereby generating the common image. For the purpose of the foregoing list, the first and the second body part are interchangeable. “Common” is used herein in its meaning of “joint” or “mutual”: The common image can cover the spatial region in which the first body part is located and the spatial region in which the second body part is located.

Each of the illumination patterns can be understood as a distribution, particularly a non-uniform distribution, of illumination on the respective body part. The distribution of illumination can appear differently depending on a viewing angle. For instance, in case the illumination pattern is projected using substantially undirected light with a relatively low intensity, such as a light-emitting diode (LED) light, light reflexes appearing on glossy surfaces of an object can change position depending on the viewing angle. On the other hand, if using a laser with a relatively high intensity as an illumination source, for instance, illumination patterns can be projected whose appearance, particularly whose position on non-glossy surfaces of the object, can be substantially independent of the viewing angle, at least in a direct view.

As will also be described further below with reference to the display device, projecting an illumination pattern through a display onto a body part of a subject may refer to directing one or more illuminating light beams through the display onto the object such that the illumination pattern arises on the side of the display towards the subject, particularly on the respective body part. The illumination pattern may arise at least in part also from an interaction of the one or more illuminating light beams with the display. However, the one or more illumination light beams may also substantially form the illumination pattern already before passing through the display. The illumination pattern is preferably projected using an illumination source arranged in the display device. i.e. on the side of the display away from the subject. The subject, whose body parts are illuminated, can be part of a scene comprising the subject, and may particularly be a person. The term “scene” preferably refers to an arbitrary spatial region or environment. Imaging the illuminated subject through the display can refer to capturing light reflected by the body parts and passing through the display, wherein the light may be captured by an image sensor, such as an image sensor of a front camera included in a smartphone and covered by the display.

For each projected illumination pattern, a corresponding reflection pattern may be extracted from an image captured by the image sensor. A reflection pattern may be considered as corresponding to an illumination pattern if the patterns share particular characteristics, or if, more generally, it can be determined that the reflection pattern corresponds to an imaged version of the illumination pattern, particularly a representation of the illumination pattern in terms of an image acquired through the display, wherein the terms “version” and “representation” may refer to a projection and/or transformation. Hence, a reflection pattern could also be understood as a distribution of illumination corresponding to an illumination pattern as viewed through the display. Since the display will comprise diffractive and/or scattering properties, the reflection pattern may comprise a diffraction and/or scattering pattern even though the illumination pattern, in a direct view onto the illuminated object, may comprise no or no substantial diffractive and/or scattering characteristics.

Extracting a reflection pattern from an image may comprise identifying reflection features in the image. The reflection pattern extracting unit may, for this purpose, apply any of the following exemplary means: a filtering, a selection of at least one region of interest, a formation of a difference image between an image created by the sensor signals and at least one offset, an inversion of sensor signals by inverting an image created by the sensor signals, a formation of a difference image between an image created by the sensor signals at different times, a background correction, a decomposition into colour channels, a decomposition into hue, saturation, and brightness channels, a frequency decomposition, a singular value decomposition, applying a blob detector, applying a corner detector, applying a determinant-of-Hessian filter, applying a principle curvature-based region detector, applying a maximally stable extremal regions detector, applying a generalized Hough transformation, applying a ridge detector, applying an affine invariant feature detector, applying an affine-adapted interest point operator, applying a Harris affine region detector, applying a Hessian affine region detector, applying a scale-invariant feature transform, applying a scale-space extrema detector, applying a local feature detector, applying speeded up robust features algorithm, applying a gradient location and orientation histogram algorithm, applying a histogram of oriented gradients descriptor, applying a Deriche edge detector, applying a differential edge detector, applying a spatio-temporal interest point detector, applying a Moravec corner detector, applying a Canny edge detector, applying a Laplacian of Gaussian filter, applying a difference-of-Gaussian filter, applying a Sobel operator, applying a Laplace operator, applying a Scharr operator, applying a Prewitt operator, applying a Roberts operator, applying a Kirsch operator, applying a high-pass filter, applying a lowpass filter, applying a Fourier transformation, applying a Radon-transformation, applying a Hough transformation, applying a wavelet-transformation, a thresholding, creating a binary image.

In particular, the reflection pattern may be extracted from the image by considering the reflection pattern as a distribution of reflection features in the image, wherein the reflection features may be detected in the image based on their intensity profiles. The intensity profiles may be compared to predetermined reference intensity profiles, which may be predetermined based on characteristics of the used illumination source or the illumination pattern. The intensity profiles could also be referred to as beam profiles, wherein a possible reference intensity profile could be given by the profile of a beam emitted by an illumination source for generating an illumination pattern. A reflection feature is preferably understood as a part of the reflection pattern that can be spatially distinguished from other parts of the reflection pattern, wherein each reflection feature may have a certain spatial extent. Extracting the reflection pattern from an image may refer to cropping a patch from the image, wherein the patch comprises the distribution of reflection features. If the image is two-dimensional, the patch can have the shape of a square, a rectangle or a circle, for instance.

An image patch, i.e. a patch cropped from an image, may also be regarded as an image itself. Hence, for instance, the image providing unit may be configured to provide, as the first image, a first image patch showing a first reflection pattern corresponding to the first illumination pattern, wherein it may further be configured to provide, as the second image, a second image patch showing a second reflection pattern corresponding to the second illumination pattern. Moreover, the first reference image may be a first reference image patch showing a first reference reflection pattern, and the second reference image may be a second reference image patch showing a second reference reflection pattern. The combined similarity determining unit may be configured to determine the combined degree of similarity based on a) the first reflection pattern and the first reference reflection pattern and/or b) the second reflection pattern and the second reference reflection pattern. The first image patch and the second image patch may be cropped from a common image, and the first reference image patch and the second reference image patch may be cropped from a common reference image.

The combined degree of similarity can be determined in many ways. For instance, it can be determined based on a pixel-by-pixel comparison of the first and the second image with the first and the second reference image, respectively. In some embodiments, however, the combined similarity determining unit comprises an artificial intelligence providing unit for providing a) a first artificial intelligence, wherein the first artificial intelligence has been trained to determine a degree of similarity of the first reference image to a first input image provided as an input to the first artificial intelligence, and/or b) a second artificial intelligence, wherein the second artificial intelligence has been trained to determine a degree of similarity of the second reference image to a second input image provided as an input to the second artificial intelligence, wherein the combined similarity determining unit is configured to determine the combined degree of similarity based on a degree of similarity determined by the first artificial intelligence upon being provided with the first image as input and/or based on a degree of similarity determined by the second artificial intelligence upon being provided with the second image as input. Hence, a separate artificial intelligence may be provided for the first and the second reference image or, in other words, for the first and the second body part. In other embodiments, however, a common artificial intelligence may be provided that is trained to detect a body part shown in an input image, wherein once it has detected a first or a second body part it may be configured to function as the first and the second artificial intelligence mentioned before, respectively. It is understood that describing the common artificial intelligence in this split manner may only be a figurative manner of speaking, wherein really the common artificial intelligence may just be configured to execute the functions of both the first and the second artificial intelligence, while the step of detecting that the input image shows a first or a second body part may be hidden in inner parts of the common artificial intelligence and therefore not known to be actually carried out.

Each of the first, second and common artificial intelligence can comprise a machine learning structure, such as an artificial neural network, particularly a convolutional neural network, for instance. However, it may also be preferred to use any other machine learning model, particularly any other classification model, as first, second and/or common artificial intelligence. While convolutional neural networks are considered examples of classification models, other exemplary classification models that could be used include vision transformers or the like, for instance.

In some embodiments, the subject is a person, the first body part is the face of the person and the second body part is a finger or a hand of the person. Display devices are typically interacted with using a hand, particularly both hands, and/or one or more fingers of one hand, particularly both hands, wherein the hands and/or fingers typically need to be bare in order to conveniently provide input via input means like a keyboard or, in particular, touchscreen functionalities. They can therefore usually be conveniently used for identification purposes as well.

In some embodiments, the second body part is a finger of the person, wherein the second image has been acquired by projecting a laser spot as a second illumination pattern through the display of the display device onto the finger and imaging the illuminated finger through the display. Using a laser, skin properties can be detected.

In some embodiments, the second body part is a finger of the person, wherein the second image has been acquired by, possibly additionally, illuminating the finger through the display with a light-emitting diode (LED) and imaging the illuminated finger through the display. It is not necessary that an illumination pattern, particularly a laser spot pattern, is projected on the finger, since also uniform light and/or floodlight can be used for three-dimensionally imaging a fingerprint, particularly detecting the papillary ridges forming the fingerprint. For instance, depth-sensing as disclosed in WO 2018/091649 A1 and WO 2021/105265 A1 may be employed, which are herewith incorporated by reference in their entirety.

In some embodiments, the second body part is a hand of the person, wherein the second image has been acquired by illuminating the hand, particularly its back, through the display with infrared light and imaging the illuminated hand, particularly its back, through the display. Also in this case uniform light and/or floodlight can be used. Veins in the hand can be visualized using infrared light, such that their individual structure can be used for identifying a subject.

In some embodiments, a time series of second images is acquired, wherein a time series of second reference images is used for determining the combined degree of similarity. In this way, a subject can be identified in terms of micro-movements and/or blood perfusion in the second body part, such as a hand or finger, particularly a fingertip. If using a laser, a speckle contrast can be determined, which may also be individual.

Particular characteristics like skin properties, papillary ridges forming a fingerprint, a vein structure and micro-movements and/or blood perfusion can be extracted from the one or more second images by the same or similar techniques as the reflection features described further above. They may insofar also be considered as reflection features, and they may be compared to corresponding features extracted from one or more second reference images for determining the combined degree of similarity.

In a further aspect, a display device is provided that comprises a display, an image sensor for acquiring a first image of a first body part of a subject interacting with the display device and for acquiring a second image of a second body part of the subject through the display, and a system as described above. Preferably, the image providing unit is configured to provide an image of a body part of a subject in front of the display, wherein the image is acquired by the image sensor while the illumination source projects an illumination pattern and/or provides illumination through the display of the display device onto the body part.

More generally, the image sensor could also viewed as a separate element, in which case a device could be provided independently that comprises the system as described above and the display device, but not necessarily the image sensor or any further elements, while the device may of course interact and/or communicate with the image sensor. Since such a device could also be viewed as a system, in other words the above described system could also be viewed as comprising additionally the display of the display device or the display device as a whole in an embodiment. Hence, in an aspect, a system and/or device for identifying a subject interacting with a display device is provided, the system and/or device comprising a) a display of the display device or the display device as a whole, b) an image providing unit for providing a first image showing a first body part of the subject and a second image showing a second body part of the subject, wherein the first image has been acquired by imaging the first body part through the display of the display device and the second image has been acquired by imaging the second body part through the display, c) a combined similarity determining unit for determining a combined degree of similarity of the first image and the second image to a first reference image and a second reference image, wherein the first reference image and the second reference image correspond to a reference subject identity, and d) a subject identity determining unit for determining whether an identity of the subject corresponds to the reference subject identity based on the combined degree of similarity.

The term “display” as used herein preferably refers to a device configured for displaying one or more items of information, such as an image, a diagram, a histogram, a text and/or a sign, for instance. The display may refer to a monitor or a screen, and may have an arbitrary shape, such as a rectangular shape, for instance. Preferably, the display is an organic light emitting display (OLED) or a liquid crystal display (LCD). The term “display device” as used herein preferably refers to an electronic device comprising a display, such as a device selected from the following, for instance: a television device, a smartphone, a game console, a personal computer, a laptop, a tablet, a virtual reality device or a combination of the foregoing. As is also the case for OLEDs and LCDs, for instance, displays of electronic display devices typically comprise an electronic wiring structure used for controlling individual pixels of the display, and possibly also for touchscreen and/or further functionalities. Typically, the pixels are arranged in a periodic or quasi-periodic structure, such as in a lattice configuration, for instance. The wiring structure then inherits the periodicity or quasi-periodicity. Due to the typical dimensions of pixels, this has the effect that a display can diffract light passing through it. It is understood that a display is preferably substantially translucent or transparent, particularly for visible light and also light with higher wavelengths. This may specifically hold for pixel regions, while areas between pixels, where the wiring structure may be located, may be substantially opaque.

The image sensor is configured to acquire the first and the second image. In a preferred embodiment, the display device comprises a single camera comprising the image sensor. In other embodiments, the display device may comprise a plurality of cameras, wherein each of the cameras comprises a corresponding image sensor. A single camera may also comprise a plurality of image sensors. The image sensor, which may also be regarded as a light receiver, may be configured to generate picture pixels, such as in a one-dimensional or two-dimensional camera, for instance, based on received light that has been reflected by a body part of a subject interacting with the display device, such as a face. In particular, the image sensor can be an image sensor sensitive for light in a spectral range emitted by the one or more illumination sources.

For instance, the image sensor may comprise sensing means of a photovoltaic type, more preferably at least one semiconductor photodiode selected from the group consisting of: a Ge photodiode, an InGaAs photodiode, an extended InGaAs photodiode, an InAs photodiode, an InSb photodiode, a HgCdTe photodiode. Likewise, the image sensor may comprise sensing means of an extrinsic photovoltaic type, more preferably at least one semiconductor photodiode selected from the group consisting of: a Ge:Au photodiode, a Ge:Hg photodiode, a Ge:Cu photodiode, a Ge:Zn photodiode, a Si:Ga photodiode, a Si:As photodiode. Additionally or alternatively, the image sensor may comprise a photoconductive sensor such as a PbS or PbSe sensor, a bolometer, preferably a bolometer selected from the group consisting of a VO bolometer and an amorphous Si bolometer.

The display device may further comprise an illumination source for illuminating the first body part and/or the second body part of the subject through the display, particularly for projecting a first illumination pattern through the display onto the first body part and/or for projecting a second illumination pattern through the display onto the second body part, and/or for providing uniform illumination and/or floodlight through the display onto the first and/or the second body part. The first image can then be acquired by the image sensor by imaging the illuminated first body part through the display and/or the second image can be acquired by the image sensor by imaging the illuminated second body part through the display.

The illumination source preferably refers to a device which is configured to generate light for illuminating a part of the environment of the display device, particularly a subject interacting with the display device. In particular, the illumination source can refer to a device which is configured to generate an illuminating light beam having a configurable direction. Projecting the illumination pattern through the display onto particular body parts of a subject may refer to directing the illuminating light beam through the display onto these body parts, wherein the illuminating light beam may interact with the display, such that an illumination pattern and/or uniform illumination and/or floodlight-like illumination arises on the side of the display towards the subject, particularly on a first and/or second body part of the subject. The illumination source may be configured to directly and/or indirectly illuminate the body parts, wherein the illumination may arise in part from reflections and/or scattering at the display and/or surfaces in the environment of the subject, wherein the reflected and/or scattered light may still be at least partially directed onto body parts of the subject together with any light reaching the body parts directly from the illumination source. However, also no direct illumination is possible, in which case, for instance, the illumination source may be configured to illuminate the body parts, for instance, by directing an illuminating light beam towards a reflecting surface in the environment of the subject such that the reflected light is directed onto the body parts.

The display device may comprise one or more illumination sources, wherein each of the illumination sources may be configured to project a respective illumination pattern through the display onto a respective body part of the subject. The illumination sources may comprise an artificial illumination source, particularly a laser source and/or an incandescent lamp and/or a semiconductor light source, such as a light-emitting diode (LED), for instance, particularly an organic and/or inorganic LED. In particular, the display device may comprise one or more laser light emitters as illumination sources, such as, for instance, an LED illuminator including several laser LEDs, one or more VCSELs, refractive optics, et cetera. The light emitted by the one or more illumination sources may have a wavelength between 300 nm, particularly between 500 nm, and 1100 nm. Additionally or alternatively, the one or more illumination sources may be configured to emit light in the infrared spectral range, such as light having a wavelength between 780 nm and 3.0 μm. Specifically, light with a wavelength in the near infrared region where silicon photodiodes are applicable may be used, more specifically in the range between 700 nm and 1100 nm. Using light in the near infrared region has the advantage that the light is not or only weakly visible by human eyes and is still detectable by silicon sensors, particularly standard silicon sensors. Preferably, the display device comprises an infrared laser, particularly a near infrared laser, as a first illumination source for projecting a first illumination pattern through the display onto the first body part of the subject with light in the infrared, particularly near infrared, spectral region, and an LED as a second illumination source for projecting a second illumination pattern through the display onto the second body part of the subject with light having a wavelength in a different spectral region, particularly in a visible spectral region.

The term “projecting an illumination pattern” may generally be understood as referring to an emission of light by the respective illumination source such that an illumination pattern is generated in a spatial region, particularly on the respective body part. More specifically, particularly depending on the illumination source, the term may refer to an emission of light from the illumination source, wherein the emitted light already propagates in a beam structure forming a certain pattern, which might be regarded as an emission pattern, wherein the propagating light may interact with the environment, such as the display, to eventually form the illumination pattern, particularly on the object, wherein the illumination pattern may be different from the emission pattern. For instance, if a laser is used as illumination source, an emission pattern may be generated using a diffractive optical element (DOE), or using a vertical-cavity surface-emitting laser (VCSEL) as laser. In a preferred embodiment, a VCSEL is used as an illumination source, wherein the VCSEL is used for generating an emission pattern, particularly a set of laser rays having predefined distances to each other, wherein then no DOE may be necessary.

A “ray” as referred to herein is understood as a light beam having a relatively narrow width, particularly a width below a predetermined value. A “beam” of light may comprise one or more light rays travelling in a respective direction, wherein the light beam may be considered travelling along a central direction being defined by an average of the directions along which the one or more light rays making up the light beam travel, and wherein a light beam may be associated with a corresponding spread or widening angle. A light beam may have a beam profile corresponding to a distribution of light intensity in the plane perpendicular to the propagation direction of the light beam, which may be given by the central direction. The beam profile may, for instance, be any of the following: Gaussian, non-Gaussian, trapezoid-shaped, triangle-shaped, conical. In particular, for instance, a trapezoid-shaped beam profile may have a plateau region and an edge region.

The one or more illumination sources may be configured to emit light at a single wavelength or at a plurality of wavelengths. A laser may be considered to emit light at a single wavelength, for instance, while an LED may be considered to emit light at a plurality of wavelengths. The plurality of wavelengths may particularly refer to a continuous, particularly extended, emission spectrum. The one or more illumination sources may be configured to generate one or more light beams for projecting the respective illumination pattern through the display onto the respective body part. In particular, for instance, a VCSEL may also be considered as emitting a plurality of beams instead of a plurality of rays.

The one or more illumination sources may be arranged in the display device such that any light generated by the one or more illumination sources leaves the display device through the display of the display device. A propagation direction may be defined for any light, particularly any light beam, emitted by a respective illumination source as a main direction along which the emitted light propagates. The propagation direction may particularly be defined as a direction from the illumination source to the illuminated object, such as a body part. In propagation direction, the one or more illumination sources may be considered to be arranged in front of the display, while the illuminated object may be considered to be arranged behind the display. A viewing direction of a subject interacting with the display device may be opposite to the initial propagation direction of light emitted by the illumination source. The viewing direction of the subject may rather correspond to a propagation direction of light being reflected by a body part, particularly a face, towards the image sensor, i.e. in a direction in which a reflection pattern may be formed from an illumination pattern.

In passing the display, any light generated by the one or more illumination sources may experience diffraction and/or scattering by the display, which may result in or affect the illumination pattern. The display may function as a grating, wherein a wiring of the display, particularly of a screen of the display, may form gaps and/or slits and ridges of the grating. However, as will be indicated again below, diffraction at the display may be less important for light leaving the display device from the illumination source. It is understood that the display is preferably translucent or transparent for the light generated by the one or more illumination sources, at least for a substantial part thereof.

The one or more illumination sources may be configured for emitting modulated or non-modulated light, wherein, if more than one illumination source is used, the different illumination sources may have different modulation frequencies which may be used for distinguishing light beams with respect to the illumination source having emitted them.

An optical axis may be defined as pointing in a direction perpendicular to the display, particularly a surface of the display, and towards the exterior of the display device. Any light generated by the one or more illumination sources may propagate parallel to the optical axis or tilted with respect to the optical axis, wherein being tilted refers to a non-zero angle between the propagation direction and the optical axis. The display device may comprise structural means to direct any light generated by the one or more illumination sources along the optical axis or in a direction not exceeding a predetermined angle with respect to the optical axis. For instance, for this purpose, the display device may comprise one or more reflective elements or prisms. Any light generated by the one or more illumination sources may then, for instance, propagate in a direction tilted with respect to the optical axis by an angle of less than ten degrees, preferably less than five degrees or even less than two degrees. Moreover, any light generated by the one or more illumination sources may exit the display device at a spatial offset to the optical axis, wherein the offset may, however, be considered arbitrary.

The illumination pattern projected on an object like the first and the second body part may comprise one or more illumination features, wherein each illumination feature illuminates a part of the object. An illumination feature is preferably understood herein as a spatial part of the illumination pattern that is distinguishable from other spatial parts of the illumination pattern and has a specific spatial extent. Each of the illumination features may correspond to one of the reflection features described further above. Since the display comprises diffractive properties and since the illumination pattern is imaged through the display, also more than one reflection feature can correspond to a single illumination feature. The illumination pattern may be, for instance, any of the following: a point pattern, a line pattern, a stripe pattern, a checkerboard pattern, a pattern comprising an arrangement of periodic and/or non-periodic features. The illumination pattern may comprise regular and/or constant and/or periodic sub-patterns, such as triangular, rectangular or hexagonal sub-patterns, or sub-patterns comprising further convex tilings, a pseudo-random point pattern or a quasi-random pattern, a Sobol pattern, a quasi-periodic pattern, a pattern comprising one or more known features, a regular pattern, a triangular pattern, a hexagonal pattern, a pattern comprising convex uniform tilings, a line pattern comprising one or more lines, wherein the lines may be parallel or crossing. The one or more illumination features may, for instance, be one of the following: a point, a line, a plurality of lines such as parallel or crossing lines, a combination of the foregoing, an arrangement of periodic and/or non-periodic features, or any other arbitrary-shaped feature. The one or more illumination sources may be configured to generate a cloud of points. They may comprise one or more projectors configured to generate a cloud of points such that the illumination pattern comprises a plurality of point patterns, wherein the illumination sources may comprise a mask in order to generate the illumination pattern from any light initially generated by the illumination sources.

It is understood that the one or more illumination sources and the image sensor are preferably arranged behind the display, i.e. for instance, between the display and any further internal electronics of the display device. The image sensor can particularly be a digital image sensor, such as a complementary metal-oxide semiconductor (CMOS) sensor, for instance. The display is preferably a translucent display. It can be, for instance, an OLED or a liquid crystal display (LCD). Preferably, the display comprises a periodic wiring structure, such as for the control of pixels or touchscreen functionalities.

In a further aspect, a method for identifying a subject interacting with a display device is provided, the method comprising a) providing a first image showing a first body part of the subject and a second image showing a second body part of the subject, wherein the first image has been acquired by imaging the first body part through a display of the display device and the second image has been acquired by imaging the second body part through the display, b) determining a combined degree similarity of i) the first image and the second image to ii) a first reference image and a second reference image, wherein the first reference image and the second reference image correspond to a reference subject identity, and c) determining whether an identity of the subject corresponds to the reference subject identity based on the combined degree of similarity.

The system and methods described above can be used, for instance, for any of the following purposes: a position measurement in traffic technology; an entertainment application; a security application; a surveillance application; a safety application; a human-machine interface application; a tracking application; a photography application; an imaging application or camera application; a mapping application for generating maps of at least one space; a homing or tracking beacon detector for vehicles; an outdoor application; a mobile application; a communication application; a machine vision application; a robotics application; a quality control application; a manufacturing application. Any of these uses establishes a further aspect.

In a further aspect, a computer program for identifying a subject interacting with a display device is provided, the program comprising program code means for causing a system as described above to execute a method as described above, optionally when the program is run on a computer controlling the system. Since the system described above may refer to a data processing apparatus, possibly a general data processing apparatus or general purpose computer, the computer program could also be a computer program for identifying a subject interacting with a display device, comprising program code means for causing the apparatus/computer to execute the method as described above. In any case, the computer program can be stored, for instance, on a non-transitory computer-readable data medium, which may then be considered a further aspect. The program code means of the program could also be referred to as instructions.

It shall be understood that the aspects described above, and specifically the system of claim 1, the method of claim 12 and the computer program of claim 13, have similar and/or identical preferred embodiments, in particular as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

FIG. 1 shows schematically and exemplarily a system for identifying a subject interacting with a display device,

FIG. 2a shows schematically and exemplarily an acquisition of an image showing a body part corresponding to a fingertip,

FIG. 2b shows schematically and exemplarily an acquisition of an image showing a further body part corresponding to a hand,

FIG. 3a shows schematically and exemplarily an acquisition of an image showing a first body part corresponding to a face that is partially covered,

FIG. 3b shows schematically and exemplarily an acquisition of an image showing simultaneously the first body part corresponding to the covered face and a second body part corresponding to a fingertip,

FIG. 4a shows schematically and exemplarily a projection of an illumination pattern using a laser and a diffractive optical element,

FIG. 4b shows schematically and exemplarily a projection of a further illumination pattern through a display using the laser and the diffractive optical element,

FIG. 5a shows schematically and exemplarily an illumination pattern projected using a laser and a diffractive optical element, as also shown in FIG. 4a,

FIG. 5b shows schematically and exemplarily an illumination pattern projected through a display using no diffractive optical element,

FIG. 6 shows schematically and exemplarily an illumination pattern projected through a display using a laser and a diffractive optical element, as also shown in FIG. 4b,

FIG. 7 shows schematically and exemplarily a photograph of a fingertip in comparison to an image acquired by illuminating the fingertip using floodlight through a display and imaging the illuminated fingertip through the display,

FIG. 8a shows schematically and exemplarily an image acquired by illuminating the back of a hand through a display with infrared light and imaging the illuminated back of the hand through the display,

FIG. 8b shows schematically and exemplarily an image acquired similarly as the image shown in FIG. 8a,

FIG. 8c shows schematically and exemplarily an image acquired similarly as the images shown in FIGS. 8a and 8b,

FIG. 9 shows schematically and exemplarily a method for identifying a subject interacting with a display device, and

FIG. 10 shows schematically and exemplarily the method for identifying a subject interacting with the display device in a particular embodiment.

### DETAILED DESCRIPTION OF EMBODIMENTS

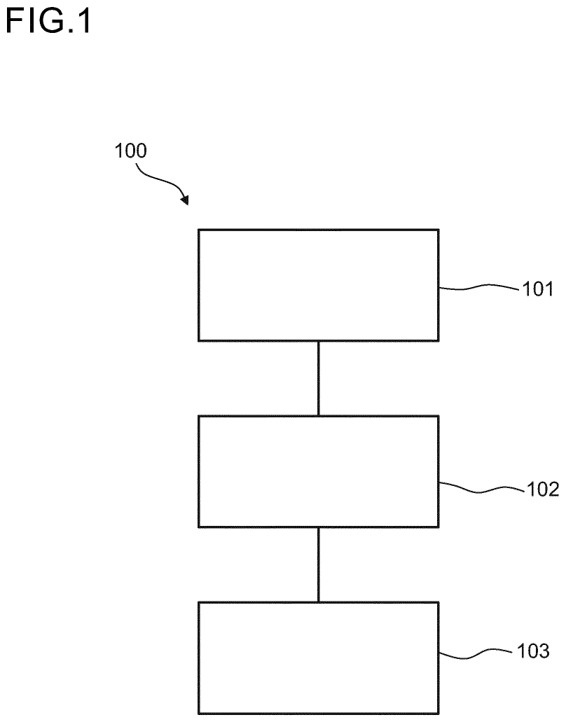

FIG. 1 shows schematically and exemplarily a system 100 for identifying a subject interacting with a display device 200, the system comprising a) an image providing unit 101 for providing a first image showing a first body part 10, 11, 12 of the subject and a second image showing a second body part 10, 11, 12 of the subject, wherein the first image has been acquired by imaging the first body 10, 11, 12 part through a display 201 of the display device 200 and the second image has been acquired by imaging the second body part 10, 11, 12 through the display, b) a combined similarity determining unit 102 for determining a combined degree of similarity of i) the first image and the second image to ii) a first reference image and a second reference image, wherein the first reference image and the second reference image correspond to a reference subject identity, and c) a subject identity determining unit 103 for determining whether an identity of the subject corresponds to the reference subject identity based on the combined degree of similarity.

The system 100 may be included in the display device 200 in addition to the display 201 and an image sensor 203 for acquiring the first image of the first body part 10, 11, 12 of the subject interacting with the display device 200 and for acquiring the second image of the second body part 10, 11, 12 of the subject through the display. The system 100 may, for instance, be included in inner electronic control means of the display device 200.

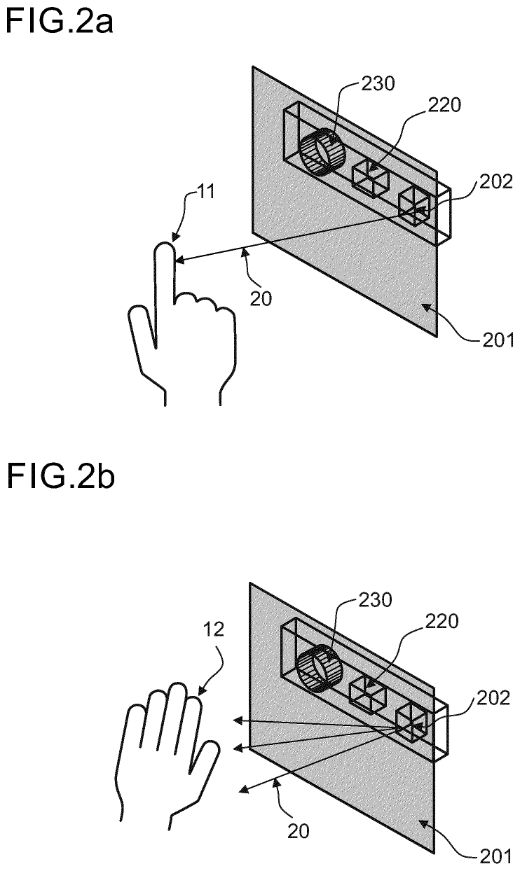

As illustrated schematically and exemplarily in FIGS. 2a and 2b, the display device 200 may further comprise illumination sources 202, 220 and a camera 230, wherein the camera 230 may comprise the image sensor 203. The illumination sources may correspond to a laser projector 202 and an LED 220. The illumination sources 202, 220 and the camera 230 may be arranged in a common optical module behind the display 201 of the display device 200. The first image may be acquired by projecting a first illumination pattern 20 through the display 201 onto the first body part, which may usually be a face 10, but, as illustrated, also a finger 11 or a hand 12, and imaging the illuminated first body part through the display 201. The second image may be acquired by projecting a second illumination pattern 20 through the display 201 onto the second body part, which may particularly be a finger 11 or a hand 12, for instance, and imaging the illuminated second body part through the display 201. As indicated in FIGS. 2a and 2b, the first and the second illumination pattern may be generated using one or more laser beams projected by a laser projector through the display 201.

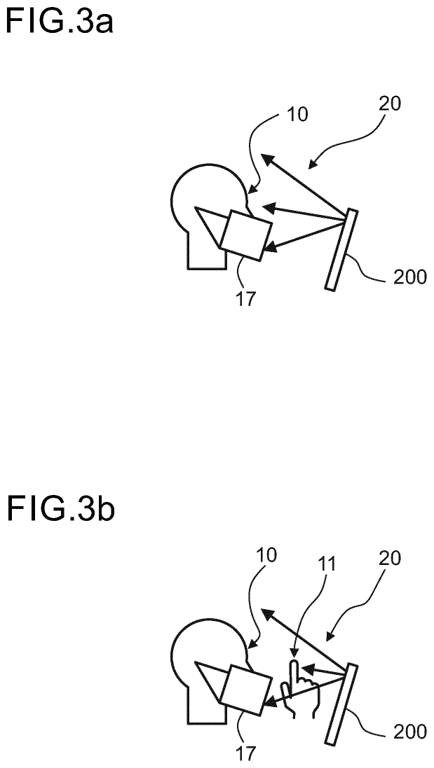

As schematically and exemplarily illustrated in FIGS. 3a and 3b, the first or the second body part, particularly the first body part, may be a face 10 of a person interacting with the display device 200, wherein this face may be covered partially by a face mask 17. If the person holds a further body part, such as a finger 11, close to his or her face 10, an image can be acquired through the display of the display device 200 showing both the face 10 and the further body part, particularly the finger 11. In such a case, the image providing unit 101 may be configured to provide the first image and the second image based on a common image of the subject, wherein the first image corresponds to a first patch of the common image and the second image corresponds to a second patch of the common image, wherein the common image can be acquired by projecting a common illumination pattern 20 through the display of the display device onto the first body part, such as the face 10 in FIG. 3b, and imaging the illuminated first body part and the second body part, such as the finger 11 in FIG. 3b, through the display. Biometric data of both the face 10 and the finger 11 may therefore be collected, possibly from a common image, for identifying the person, which may overcome the problems for identifying the person posed by the person wearing the face mask 17.

The common illumination pattern 20 may also be projected onto the second body part, such as the finger 11, wherein then the illuminated second body part is imaged. A common illumination pattern may, for instance, be acquired by one or more laser points being projected onto each of the face 10 and the finger 11. Known material detection methods, such as described in WO 2020/187719 A1, for instance, which is herewith incorporated by reference in its entirety, can be used to determine, based on the acquired image or images, whether the finger 11 is a real skin finger, just as they may be used to determine whether the skin in the face 10 is the skin of a real human.

It is also possible to acquire a time series of laser images of the finger 11, wherein from the time series of laser images a blood perfusion and/or micromovements of the finger 11 may be determined based on a measurement of speckle contrast, thereby providing for very particular biometrical characteristics. Additionally or alternatively to laser images, floodlight images can be acquired in order to analyse the surface of the finger 11, which may result in a determination of a fingerprint of the person. Known depth sensing techniques, particularly those relying only on a single camera, as described, for instance, in WO 2018/091649 A1 and WO 2021/105265 A1, may be employed to detect the correct scale of the fingerprint. An LED light may be used as illumination source for generating floodlight images, for instance. It is understood that a fingerprint offers valuable biometric information, particularly as encoded, for instance, in papillary ridges. Papillary ridges may be extracted from floodlight images.

The face mask 17 shown in FIGS. 3a and 3b can be, for instance, a face mask as used, for instance, for protection against droplet-transmitted diseases, like COVID-19. Hence, FIGS. 3a and 3b also illustrate that using an additional body part for identification allows for unlocking, for instance, a smartphone without pulling off the face mask 17, thereby also providing for an increased protection against droplet-transmitted diseases, like COVID-19.

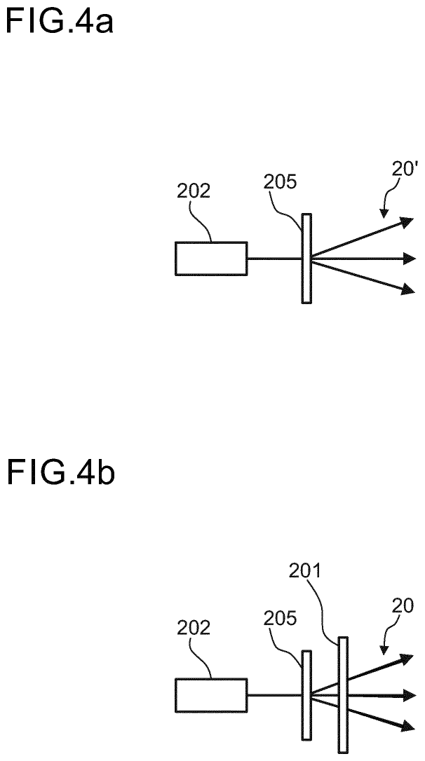

FIGS. 4a and 4b schematically and exemplarily illustrate the formation of illumination patterns using a laser projector 202 as an illumination source of the display device 200. The illumination source may comprise, apart from the laser 202, a diffractive optical element (DOE) 205, wherein an initial illumination pattern 20′, which may also be regarded as an emission pattern, is formed by a laser beam ejected by the illumination source and subsequently diffracted by the DOE 205. If the illumination source comprising the laser 202 and the DOE 205 is arranged behind a display 201 of a display device, the diffracted laser beam is subsequently also diffracted by the display 201, which, due to the electronic wiring structure necessary for controlling the display 201, acts as a further diffractive element in the laser beam path.

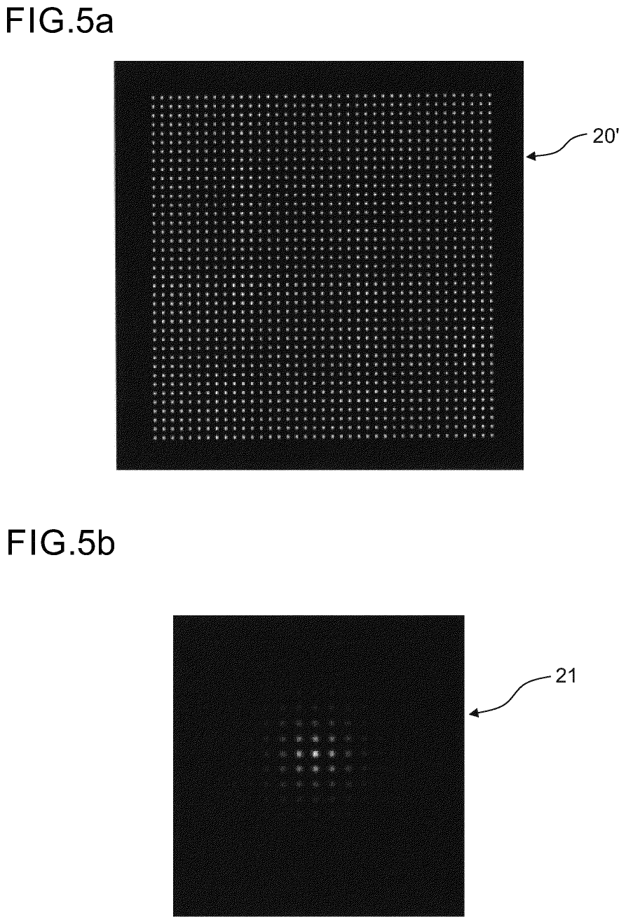

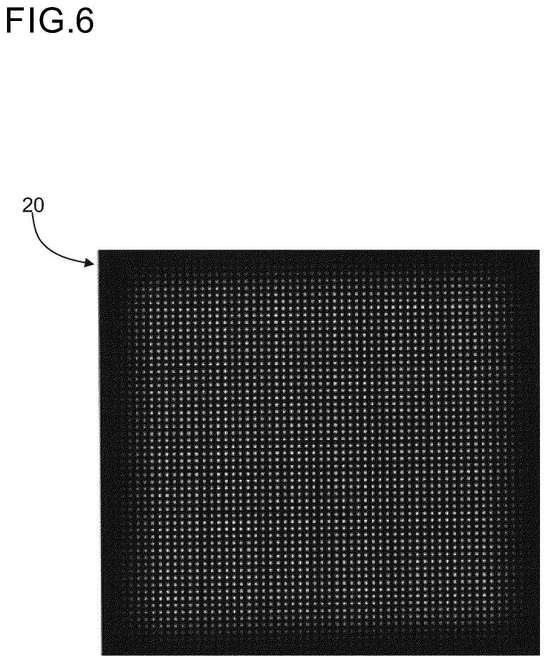

FIGS. 5a and 5b show separately imaged diffraction patterns associated with a DOE and an organic light emitting display (OLED). It can be appreciated from FIGS. 5a and 5b that diffraction favours the projector pattern, i.e. the emission pattern 20′, over the further diffraction pattern 21 caused by the OLED. This also follows from FIG. 6, which shows an illumination pattern 20 arising from the emission pattern passing through the display 201. The illumination pattern 20 is an illumination pattern with little optical disturbances by the display 201, thereby leading to a good resolution of the final illumination pattern by which, for instance, the first and the second body part of the subject interacting with the display device 200 may be illuminated. FIG. 6 shows only a particular example of an illumination pattern 20 that can be used. In particular, as partially already indicated further above, also illumination patterns comprising, for instance, a hexagonal, a hexagonal-shifted or a triclinic structure can be used, wherein the structure can be uniform or non-uniform, and wherein also the individual illumination features can have other than round shapes.

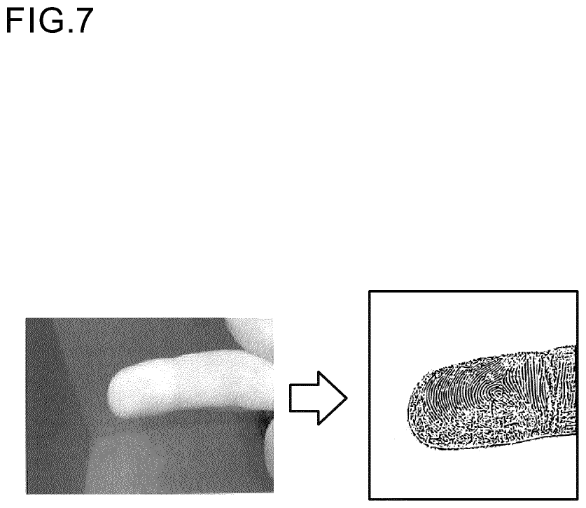

FIG. 7 shows schematically and exemplarily an extraction of a fingerprint comprising papillary bars from a floodlight image. Fingerprint images can also be acquired, for instance, by using, as illumination pattern, a laser dot projected by a dot projector onto a target finger. As already mentioned above, known material detection algorithms can be used to decide if the imaged finger is a real human finger.

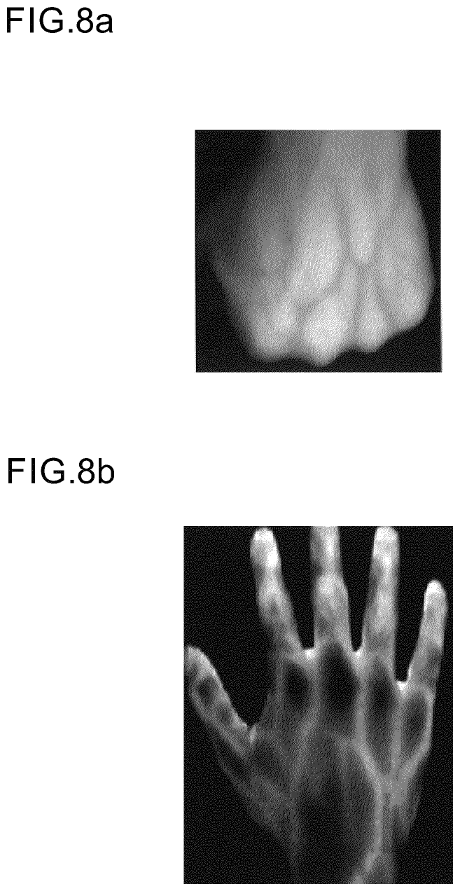

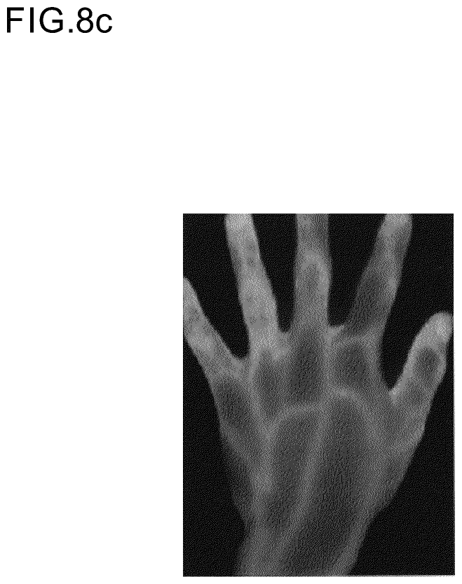

FIGS. 8a to 8c show biometrical features that can be extracted from infrared images of the back of a hand and might therefore serve as additional authentication features. The features shown in FIGS. 8a to 8c correspond to veins in the hand. Veins are visible in infrared light and their structure is person-specific, thereby offering for a unique identification of a person. After reconstruction of an infrared image acquired through, for instance, an OLED using known algorithms and/or convolutional neural networks, as described, for instance, in WO 2021/105265 A1, the structure of the veins can be extracted.

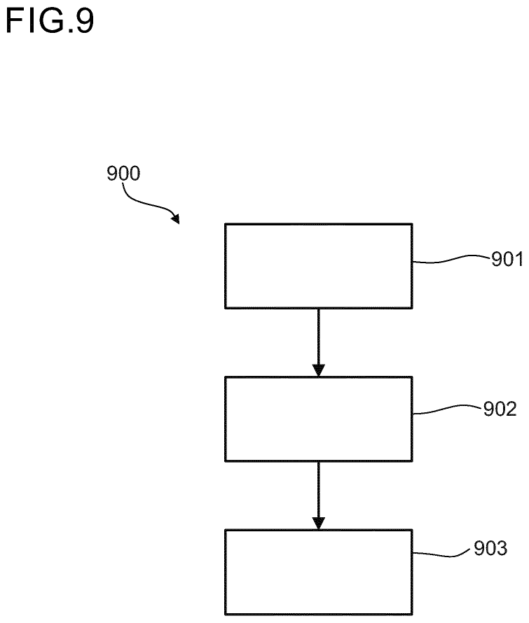

FIG. 9 shows schematically and exemplarily a method 900 for identifying a subject interacting with a display device 200, the method comprising a step 901 of providing a first image showing a first body part 10, 11, 12 of the subject and a second image showing a second body part 10, 11, 12 of the subject, wherein the first image has been acquired by imaging the first body part 10, 11, 12 through a display 201 of the display device 200 and the second image has been acquired by imaging the second body part 10, 11, 12 through the display 201, a step 902 of determining a combined degree similarity of the first image and the second image to a first reference image and a second reference image, wherein the first reference image and the second reference image correspond to a reference subject identity, and a step 903 of determining whether an identity of the subject corresponds to the reference subject identity based on the combined degree of similarity.

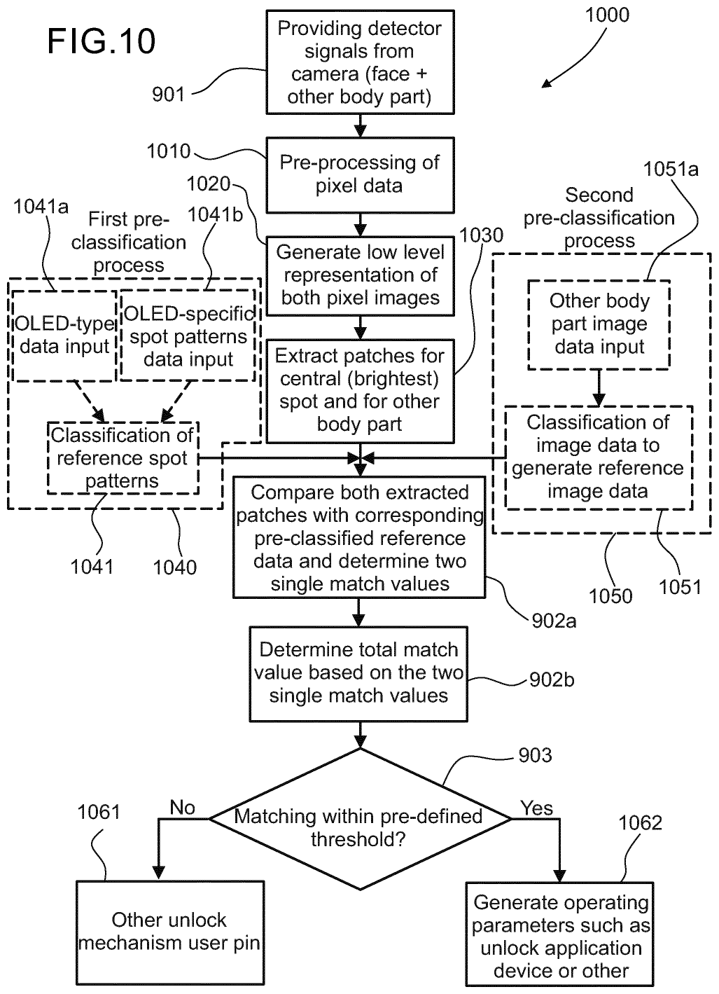

FIG. 10 illustrates schematically and exemplarily a particular method 1000 for identifying a subject interacting with a display device 200. The first image and the second image provided in step 901 show, in this case, a face and another body part of the subject. The first and the second image may be a single image and may be received, in terms of image data, from the image sensor 203, which may also be regarded as a detector providing detection signals. The image data, which may comprise pixel data, are then pre-processed in step 1010. From the pre-processed image data, a low-level representation of the image data is generated in a step 1020, i.e. a low-level representation of the image data corresponding to each of the images or to the single image showing both the face and the other body part. Then, in a step 1030, a respective image patch is extracted for each of the face and the other body part. In the particular case illustrated, the face may have been imaged by projecting an illumination pattern corresponding to a spot pattern through the display onto the face and imaging the illuminated face through the display, and the other body part may have been imaged by illuminating the other body part through the display with floodlight and then imaging the illuminated other body part through the display. The image patches may correspond to a first patch showing a region of the face where a central spot and possibly satellite spot of a reflection pattern corresponding to the illumination pattern appears, and a second patch with a focus on the other body part. In step 902a, the extracted image patches are compared with corresponding pre-classified reference data, i.e. first and second reference image patches, in order to determine a respective first degree of similarity between the first image patch and a respective first reference image patch, and a respective second degree of similarity between the second image patch and a respective second reference image patch. The respective first and second degrees of similarity may also be understood as first and second match values.

The reference image patches have been classified in a first pre-classification process 1040 and a second pre-classification process 1050. In the first pre-classification process 1040, a plurality of first reference image patches showing the faces of reference subjects may have been collected and provided in step 1041b, wherein the first reference images may have been acquired in step 1041b through different display, particularly OLED, types, such that display-type specific image data of the faces of the reference subjects are provided, wherein to each first reference image the respective display type may be associated in step 1041 based on corresponding type data, such as a technical type, the production year or lot, provided in step 1041a. Moreover, also the respective identity of the reference subject may be associated to the first reference images. The illumination patterns used for acquiring the first reference images preferably correspond to the illumination pattern used for acquiring the first image of the subject to be identified, i.e. may in this case be spot patterns.

In the second pre-classification process 1050, a plurality of second reference image patches showing the respective other body part of reference subjects may have been collected and provided in step 1051a, wherein the second reference image patches may have been classified in step 1051 by the identity of the respectively imaged reference subject. The first pre-classification process 1040 and the second pre-classification process 1050 preferably uses reference images of the same reference subjects.

In step 902b, a respective combined degree of similarity is determined based on the respective first and second degree of similarity, wherein the combined degree of similarity may also be regarded as a combined, i.e. single, match value. The combined degree of similarity may be determined, for instance, using a) a first artificial intelligence, wherein the first artificial intelligence has been trained to determine a degree of similarity of any of the first reference images to a first input image provided as an input to the first artificial intelligence, and/or a second artificial intelligence, wherein the second artificial intelligence has been trained to determine a degree of similarity of any of the second reference image to a second input image provided as an input to the second artificial intelligence, wherein, for any given first and/or second reference image, the combined degree of similarity may be determined based on a degree of similarity determined, as first degree of similarity, by the first artificial intelligence upon being provided with the first image as input and/or based on a degree of similarity determined, as second degree of similarity, by the second artificial intelligence upon being provided with the second image as input.

In step 903, it is determined whether the combined degree of similarity for an expected reference subject is above a predefined threshold. If so, the subject may be assumed as authenticated, and operating parameters for certain functions of the display device may generated in step 1062, such as for unlocking the device or an application running on the device. If not, the subject may not (yet) be assumed as authenticated, and other unlock mechanisms, such as the entry of a user pin, may be triggered in a step 1061.

One of the findings disclosed herein relates to performing a two-factor authentication of a person based on face recognition technology in combination with another recognition technology, such as fingerprint (or hand palm or back) recognition technology. This can be done, for instance, using a known face recognition technology and without changing the sensor means with respect thereto, i.e. using one and the same sensors as for the known face recognition technology, namely an illumination projector and a camera, particularly a single camera. It has been found that this kind of two-factor authentication allows for an improved reliability and safety over the known recognition technology, which is particularly based on sensor technology arranged behind a translucent display (e.g. an OLED display), as partially briefly summarized in the following.

There exist approaches for recognizing (e.g. identifying or authenticating) a person by means of face detection or recognition, based on laser equipment being arranged inside e.g. a smart phone, i.e. behind a translucent display (e.g. OLED display).

In addition, a technology for measuring distance of an object as well as the material of that object was developed. Standard hardware is used: an IR laser point projector (e.g. VCSEL array) for projecting a spot pattern onto the object and a CMOS camera which records the object under illumination. In contrast to the well-established structured light approach, only one camera is necessary. The distance information as well as the material information is extracted from the shape of a laser spot reflected by the object. The ratio of the light intensity in the central part of the spot to that in the outer part of the spot contains distance information. The technology is disclosed in WO 2018/091649 A1, which, as already indicated above, is herewith incorporated by reference in its entirety.

The material can also be extracted from the intensity distribution of the reflected spot due to the fact that each material reflects light differently. In particular, skin can be detected due to the fact that IR light penetrates skin relatively deeply leading to a certain spot broadening. The material analysis is done by applying a series of filters to the image to extract different information of the spot. This method is disclosed in WO 2020/187719, which, as already indicated above, is incorporated herewith by reference in its entirety.

The combination of depth measurement and material detection enables, for instance, the 3D reconstruction of a face by selecting only those spots corresponding to skin and determining their distance. This can be used for face authentication which can hardly be spoofed using images or silicone masks. The measurement can be further improved by combining the 3D data with a two-dimensional image which is taken by the camera while the object is under flood illumination. This means that the object is at least once illuminated with flood light and shortly after (or before) with structured light.

Thereupon, WO 2021/105265 A1, which, as already indicated above, is incorporated herewith by reference in its entirety, discloses a “DPR” technology which has the advantage that it is robust against disturbances. Hence, if the projector and the camera is put behind an OLED display, the reflection image is disturbed by scattering (caused by the electrical micro-wiring structure needed for display control), but the DPR technology is robust enough that it can still measure distance and material of a detected object or person. The zero-order scattering spot, so the most intense spot, can be analysed and the higher order scattered spots can be discarded.

A display device as disclosed herein in an embodiment can include a translucent display (LCD, OLED, etc.) comprising a periodic wiring structure (for control of pixels, touchscreen, etc.). Behind the display there is arranged at least one laser light emitter (e.g. LED illuminator including several laser LEDs, one or more VCSELs, refractive optics, etc.) and a light receiver which generates picture pixels (e.g. a digital 1D or 2D camera), based on the received light being reflected by a person's face or an object. The emitted laser light (i.e. at least one spot, a spot pattern or a floodlight—“Flächenstrahler” in German) strikes a person's face, together with another body part, like a hand or a finger, in front of the display, wherein the reflected light is received by the light receiver, thus generating at least one picture. The at least one received picture (preferably a 2D image), in particular the reflected light spot or spot pattern (preferably pictures of the reflected laser image together with a floodlight—e.g. LED light—picture, because using both picture types provides more features, thus increasing reliability/security of person/object identification), is evaluated by means of image processing. Hereby, the at least one laser and/or floodlight-based picture receives a (2D) picture of the person, from the digitalized (2D) picture at least one first patch (square, rectangle, circle) is extracted which includes a central (brightest) spot, and maybe all other by diffraction/grating caused (satellite) spots, together with at least one second patch (square, rectangle, circle) which includes the image of the other body part, e.g. finger or hand.

The at least two extracted patches may be further processed by a) comparing the received spot pattern within the at least one first patch with existing (expected) and/or pre-classified reference spot patterns, e.g. by means of pixel-by-pixel evaluation, pattern recognition using artificial neural network (machine learning) or other (standard) image processing methods; b) comparing the received image of the other body part within the at least one second patch with existing (expected) and/or pre-classified images of the other body part of the person or object, e.g. by means of pixel-by-pixel evaluation, pattern recognition using artificial neural network (machine learning) or other (standard) image processing methods; c) determining a total match value (or score), dependent on the results of the two preceding comparing steps, e.g. based on corresponding predefined threshold values.

Based on the determined total match value, a device-specific identification of the person/object can be performed that allows for unlocking such devices, touch screens and/or applications. Additionally or alternatively, by means of material detection, which can be achieved by known methods, the received images of the other body part of a person can include information about skin properties and/or blood flow, thus enabling an identification of a real skin finger (in order to detect spoofing using fake skin finger-like objects). A particular material detection can be achieved as disclosed in WO 2020/187719 A1, as already referred to above. Furthermore, additionally or alternatively, by means of additional evaluation of 3D data, the correct scale of the other, i.e. particularly non-facial, body part can be detected. In particular, 3D, or “depth”, data can be obtained as disclosed in WO 2018/091649 A1 and WO 2021/105265 A1, as already referred to above. The measures disclosed herein do not rely on such depth measurements, nor on the mentioned material detection. But, they are compatible with them.

More reliable and safe identification/authentication of persons and objects has been achieved, particularly based on a 2-factor identification which additionally evaluates features of another body part of the person/object. Notably, an identification process can be successfully carried out even with a partly occluded face (e.g. partly masked or amended by make-up) or object.

A display device is presented having, in some embodiments, at least one translucent display configured for displaying information, comprising i) at least one illumination source being arranged behind the translucent display and configured for projecting at least one illumination pattern comprising a plurality of illumination features, through the translucent display, on at least one person or object, ii) at least one optical sensor being arranged behind the translucent display and having at least one light sensitive area, wherein the optical sensor is configured for determining at least one first image comprising a light pattern generated by the person/object in response to illumination by the illumination features and for determining at least one second image including a different part of the person or object, iii) at least one evaluation device, wherein the evaluation device is configured for a) evaluating the at least one first image and the at least one second image, wherein the evaluation of the at least one first image comprises identifying the illumination features of the first image based on at least one beam profile and comparing reflected light patterns of the at least one beam profile with reference light patterns and for determining a first match value between a reflected light pattern and the reference light patterns, and wherein the evaluation of the at least one second image comprises comparing the at least one second image of the other body part with existing (expected) and/or pre-classified images of the other part of the person or object, and for b) determining a total match value (or score), based on the determined first and second match values, e.g. based on corresponding predefined threshold values.

Moreover, a method for measuring through a translucent display of at least one display device as defined above is presented, wherein the method comprises the steps of a) evaluating the at least one first image and the at least one second image, wherein the evaluation of the at least one first image comprises identifying the illumination features of the first image based on at least one beam profile and comparing reflected light patterns of the at least one beam profile with reference light patterns and for determining a first match value between a reflected light pattern and the reference light patterns, and wherein the evaluation of the at least one second image comprises comparing the at least one second image of the other body part with existing (expected) and/or pre-classified images of the other part of the person or object, and b) determining a total match value (or score), based on the determined first and second match values, e.g. based on corresponding predefined threshold values.

Although in the above-described embodiments a subject interacting with a display device is identified, also other objects may be identified using the same means. A subject may insofar be understood as a particular object, wherein also an object may be considered to have a body with a plurality of body parts that may be imaged.

Although in the above-described embodiments reference was made mainly to a first and a second body part, it will be understood that equal measures extend to any number of further body parts. The present disclosure may therefore be considered as providing multi-factor authentication means.

Even if in the above-described embodiments some functions have been described only with respect to the first body part or the second part, the same functions may be applicable to the respective other body part, since, in particular, they do not technically depend on what is imaged.

Other variations to the disclosed embodiments can be understood and effected by those skilled in the art in practicing the claimed invention, from a study of the drawings, the disclosure, and the appended claims.

The term “image” as used herein is not limited to an actual visual representation of the imaged object. Instead, an “image” as referred to herein can be generally understood as a representation of the imaged object in terms of data acquired by imaging the object, wherein “imaging” can refer to any process involving an interaction of electromagnetic waves, particularly light or radiation, with the object, specifically by reflection, for instance, and a subsequent capturing of the electromagnetic waves using an optical sensor, which might then also be regarded as an image sensor. In particular, the term “image” as used herein can refer to image data based on which an actual visual representation of the imaged object can be constructed. For instance, the image data can correspond to an assignment of color or grayscale values to image positions, wherein each image position can correspond to a position in or on the imaged object. The images or image data referred to herein can be two-dimensional, three-dimensional or four-dimensional, for instance, wherein a four-dimensional image is understood as a three-dimensional image evolving over time and, likewise, a two-dimensional image evolving over time might be regarded as a three-dimensional image. An image can be considered a digital image if the image data are digital image data, wherein then the image positions may correspond to pixels or voxels of the image and/or image sensor.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage. Procedures like the providing of an image, the determining of a combined degree of similarity, the determining of whether identities correspond, et cetera, performed by one or several units or devices can be performed by any other number of units or devices. These procedures can be implemented as program code means of a computer program and/or as dedicated hardware. A computer program product may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

1. A system for identifying a subject interacting with a display device, the system comprising
an image providing unit for providing a first image showing a first body part of the subject and a second image showing a second body part of the subject, wherein the first image has been acquired by imaging the first body part through a display of the display device and the second image has been acquired by imaging the second body part through the display,
a combined similarity determining unit for determining a combined degree of similarity of a) the first image and the second image to b) a first reference image and a second reference image, wherein the first reference image and the second reference image correspond to a reference subject identity, and
a subject identity determining unit for determining whether an identity of the subject corresponds to the reference subject identity based on the combined degree of similarity.

2. The system according to claim 1, the first image has been acquired by projecting a first illumination pattern through the display onto the first body part and imaging the illuminated first body part through the display.

3. The system according to claim 1, wherein the second image has been acquired by projecting a second illumination pattern through the display onto the second body part and/or illuminating the second body part uniformly through the display, and imaging the illuminated second body part through the display.

4. The system according to claim 1, wherein the image providing unit is configured to provide the first image and the second image based on a common image of the subject, wherein the first image corresponds to a first patch of the common image and the second image corresponds to a second patch of the common image.

5. The system according to claim 1, wherein the combined similarity determining unit comprises
an artificial intelligence providing unit for providing:
a) a first artificial intelligence, wherein the first artificial intelligence has been trained to determine a degree of similarity of the first reference image to a first input image provided as an input to the first artificial intelligence, and/or
b) a second artificial intelligence, wherein the second artificial intelligence has been trained to determine a degree of similarity of the second reference image to a second input image provided as an input to the second artificial intelligence,
wherein the combined similarity determining unit is configured to determine the combined degree of similarity based on a degree of similarity determined by the first artificial intelligence upon being provided with the first image as input and/or based on a degree of similarity determined by the second artificial intelligence upon being provided with the second image as input.

6. The system according to claim 1, wherein the subject is a person, the first body part is the face of the person and the second body part is a finger or a hand of the person.

7. The system according to claim 6, wherein the second body part is a finger of the person, wherein the second image has been acquired by projecting a laser spot as a second illumination pattern through the display onto the finger and imaging the illuminated finger through the display.

8. The system according to claim 6, wherein the second body part is a finger of the person, wherein the second image has been acquired by illuminating the finger through the display with a light-emitting diode and imaging the illuminated finger through the display.

9. The system according to claim 6, wherein the second body part is a hand of the person, wherein the second image has been acquired by illuminating the hand through the display with infrared light and imaging the illuminated hand through the display.

10. The system according to claim 6, wherein a time series of second images is acquired, and wherein a time series of second reference images is used for determining the combined degree of similarity.

11. A display device comprising:
a display,
an image sensor for acquiring a first image of a first body part of a subject interacting with the display device and for acquiring a second image of a second body part of the subject through the display, and
the system according to claim 1.

12. A method for identifying a subject interacting with a display device, the method comprising:
providing a first image showing a first body part of the subject and a second image showing a second body part of the subject, wherein the first image has been acquired by imaging the first body part through a display of the display device and the second image has been acquired by imaging the second body part through the display,
determining a combined degree similarity of the first image and the second image to a first reference image and a second reference image, wherein the first reference image and the second reference image correspond to a reference subject identity, and
determining whether an identity of the subject corresponds to the reference subject identity based on the combined degree of similarity.

13. A computer program for identifying a subject interacting with a display device, the program comprising program code means for causing a system to execute the method according to claim 12, when the program is run on a computer controlling the system.
